(19) United States
(12) Patent Application Publication
(10) Pub. No.: US 2023/0013906 A1
(43) Pub. Date: Jan. 19, 2023

(54) BATTERY MODULE AND BATTERY PACK INCLUDING THE SAME

(71) Applicant: LG Energy Solution, LTD., Seoul (KR)

(72) Inventor: Hyun Wook Jeon, Daejeon (KR)

(21) Appl. No.: 17/797,616

(22) PCT Filed: Jul. 30, 2021
(86) PCT No.: PCT/KR2021/009946

§ 371 Date: Aug. 4, 2022

(30) Foreign Application Priority Data
Sep. 22, 2020 (KR) 10-2020-0122292

(51) Int. Cl. H01M 50/691; H01M 50/507

(52) U.S. Cl. CPC H01M 50/691; H01M 50/507

(57) ABSTRACT

A battery module including: a battery cell stack in which a plurality of battery cells are stacked; a housing for housing the battery cell stack; a pair of end plates for covering the front and rear surfaces, respectively, of the battery cell stack; and + a drainage channel at a lower end corner of at least one of the pair of the end plates where the end plate meets the housing.

### CROSS-REFERENCE TO RELATED APPLICATIONS

This application is a US national phase of international Application No. PCT/KR2021/009946 filed on Jul. 30, 2021, and claims the benefit of Korean Patent Application No. 10-2020-0122292 filed on Sep. 22, 2020 with the Korean Intellectual Property Office, the disclosures of which are incorporated herein by reference in their entirety.

### TECHNICAL FIELD

The present disclosure relates to a battery module and a battery pack including the same, and more particularly, to a battery module for preventing a short circuit between busbars, and a battery pack including the same.

### BACKGROUND

A secondary battery has attracted much attention as an energy source in various products such as a mobile device and an electric vehicle. The secondary battery is a potent energy resource that can replace the use of existing products that consume fossil fuels, and is in the spotlight as an environment-friendly energy source because it does not generate by-products due to energy use.

Recently, along with a continuous rise in demand for a large-capacity secondary battery structure, including the utilization of the secondary battery as an energy storage source, there is a growing demand for a battery pack having a multi-module structure, which is an assembly of battery modules in which a plurality of secondary batteries are connected in series/parallel.

Meanwhile, when a plurality of battery cells are connected in series/parallel in a battery pack, a common method of manufacturing the battery pack includes manufacturing a battery module composed of at least one battery cell and then adding other components to the at least one battery module.

The battery module may include a battery cell stack in which a plurality of battery cells are stacked, a housing for housing the battery cell stack, and an end plate for covering the front and rear surfaces of the battery cell stack.

FIG. 1 is a perspective view of a bottom part of a conventional battery module. FIG. 2 is an enlarged view of section A of FIG. 1. FIG. 3 is a view from the inside surface of the end plate of the conventional batter module of FIG. 1.

As illustrated in FIGS. 1 to 3, the conventional battery module may include a housing 20 for housing the battery cell stack, and an end plate 30 for covering the front and rear surfaces of the battery cell stack. As illustrated in FIG. 3, a separate water discharge structure does not exist on the end plate. When the battery module does not have a water discharge structure, moisture may flow into the battery module from the outside. Further, water vapor that flows into the battery module may be condensed to generate moisture inside the battery module. Further, the electrolyte solution may leak from the battery cell, and the leaked electrolyte solution may be seated inside the housing.

When liquid is generated inside the battery module in this way, the busbars connected to the battery cells may be immersed in the liquid. With the immersed busbars being corroded, a short circuit phenomenon between busbars may occur, which may cause a fire, and deteriorate the performance of the battery module.

### DETAILED DESCRIPTION

It is an objective of the present disclosure to provide a battery module that includes a structure for discharging a liquid inside the battery module.

The objectives of the present disclosure are not limited to the aforementioned objective, and other objectives which are not described herein should be clearly understood by those skilled in the art from the following detailed description.

According to one exemplary embodiment of the present disclosure, there is provided a battery module comprising: a battery cell stack in which a plurality of battery cells are stacked; a housing for accommodating the battery cell stack; and an end plate for covering the front and rear surfaces of the battery cell stack, wherein a drainage channel is formed at both lower corner parts of the end plate where it meets the housing.

A portion where the end plate and the housing meet, excluding the portion where the drainage channel is formed, may be joined by welding.

The drainage channel may have a first slope toward the outside corner part of the lower end of the end plate, and an inside lower end part of the end plate connected to the drainage channel may have a second slope toward the drainage channel.

The first slope may have a larger slope/inclination angle than the second slope.

The drainage channel may be formed from the inside corner part of the lower end of the end plate toward the outside corner part of the lower end.

A rim part protruding toward the housing may be formed on the edge part of the end plate, and the drainage channel may be formed in the rim part.

An insulating cover may be formed between the battery cell stack and the end plate, and an inside lower end part of the end plate may be formed on the lower side of the insulating cover.

A pair of busbar frames may be formed on the front and rear surfaces of the battery cell stack, respectively, and each of the busbar frames may be connected to an upper part of an inside lower end part of the corresponding end plate.

A plurality of busbars may be mounted on the outside surface of the busbar frame, and the plurality of busbars may be connected to an upper part of the inside lower end part.

According to one exemplary embodiment of the present disclosure, there is provided a battery pack comprising: the above-mentioned battery module, and a drainage device connected to the drainage channel of the battery module.

In a battery module and a battery pack including the same according to exemplary embodiments of the present disclosure, a drainage channel can be formed in lower corner parts of the end plate to discharge a liquid from inside the battery module to the outside.

The effects of the present disclosure are not limited to the effects mentioned above and additional other effects not described above will be clearly understood from the description of the appended claims by those skilled in the art.

### BRIEF DESCRIPTION OF THE DRAWINGS

FIG. 1 is a perspective view of a bottom part of a conventional battery module;

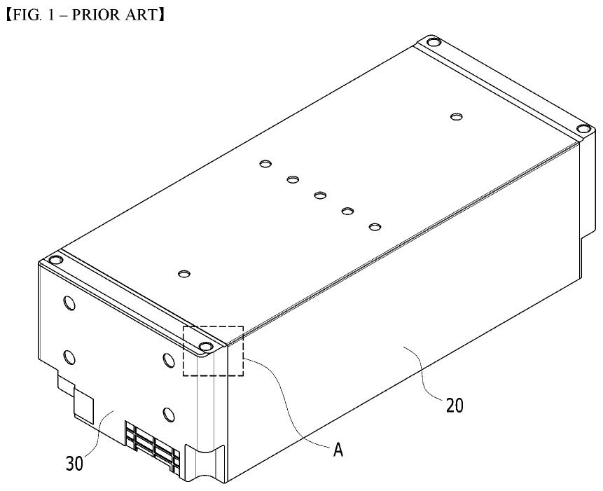

FIG. 2 is an enlarged view of section A of FIG. 1;

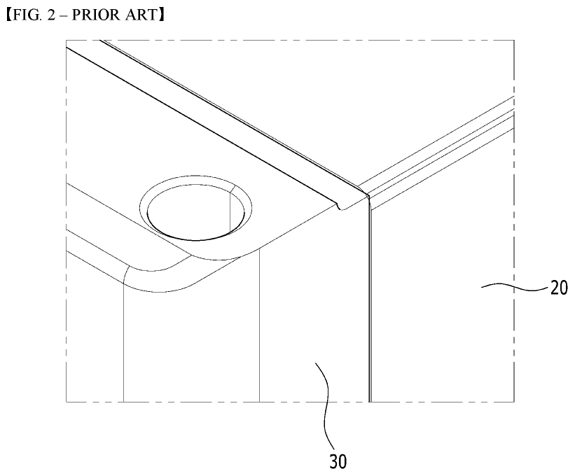

FIG. 3 is a view of the conventional battery module of FIG. 1 from the inside surface of the end plate;

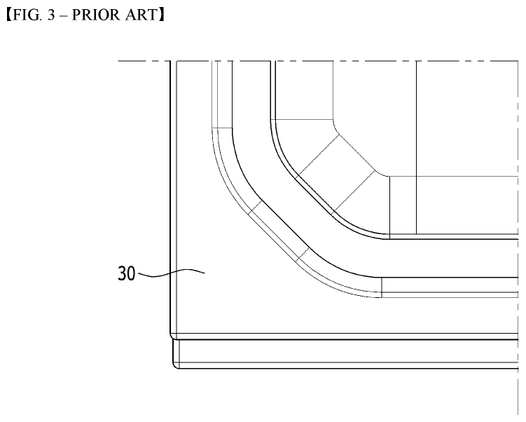

FIG. 4 is a perspective view of a bottom part of a battery module according to one exemplary embodiment of the present disclosure;

FIG. 5 is an illustration of various components inserted into the housing of FIG. 4;

FIG. 6 is an enlarged view of section B of FIG. 4;

FIG. 7 is a plan view showing the inside surface of the end plate according to one exemplary embodiment of the present disclosure; and

FIG. 8 is a perspective view of an inside surface of the end plate according to one exemplary embodiment of the present disclosure.

### DETAILED DESCRIPTION

It should be appreciated that the exemplary embodiments, which will be described below, are illustratively described to assist in the understanding of the present disclosure, and the present disclosure can be variously modified to be carried out differently from the exemplary embodiments described herein. However, in the description of the present disclosure, the specific descriptions and illustrations of publicly known functions or constituent elements will be omitted when it is determined that the specific descriptions and illustrations may unnecessarily obscure the subject matter of the present disclosure. In addition, in order to help understand the present disclosure, the accompanying drawings are not illustrated based on actual scales, but parts of the constituent elements may be exaggerated in size.

As used herein, terms such as first, second, and the like may be used to describe various components, and the components are not limited by the terms. The terms are used only to distinguish one component from another component.

Further, the terms used herein are used only to describe specific exemplary embodiments, and are not intended to limit the scope of the present disclosure. A singular expression includes a plural expression unless they have definitely opposite meanings in the context. It should be understood that the terms “comprise”, “include”, and “have” as used herein are intended to designate the presence of stated features, numbers, steps, movements, constitutional elements, parts or combinations thereof, but it should be understood that they do not preclude a possibility of existence or addition of one or more other features, numbers, steps, movements, constitutional elements, parts or combinations thereof.

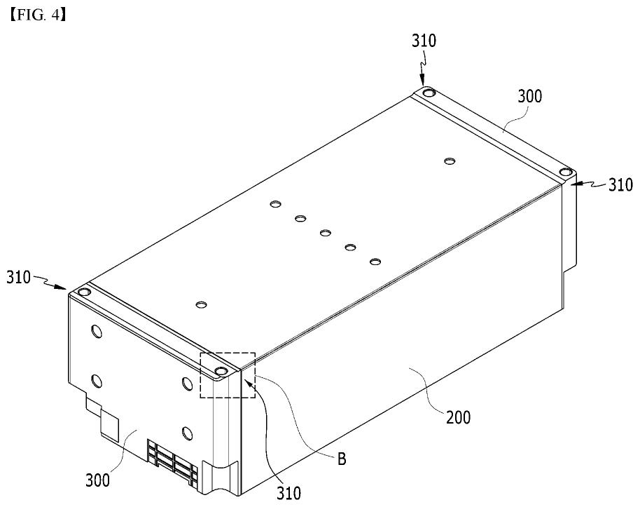

Hereinafter, a battery module having a drainage channel according to one exemplary embodiment of the present disclosure will be described with reference to FIGS. 4 to 6.

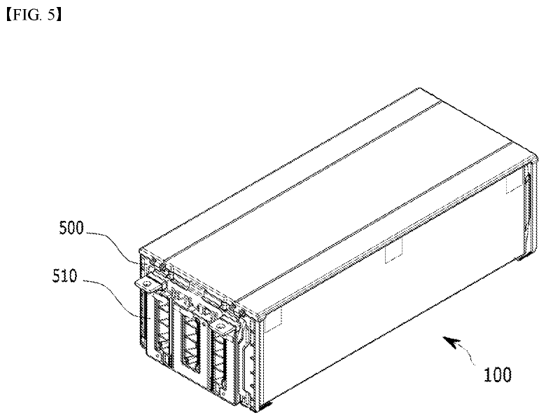

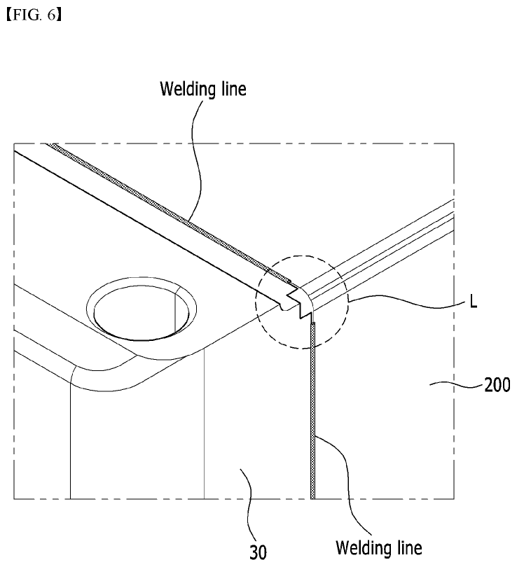

FIG. 4 is a perspective view of a bottom part of a battery module according to one exemplary embodiment of the present disclosure. FIG. 5 is an illustration of the components inserted into the housing of FIG. 4. FIG. 6 is an enlarged view of section B of FIG. 4.

As illustrated in FIGS. 4 to 6, the battery module according to one exemplary embodiment of the present disclosure includes a battery cell stack 100 in which a plurality of battery cells are stacked, a housing 200 for housing the battery cell stack 100, and a pair of end plates 300 for covering the front and rear surfaces, respectively, of the battery cell stack 100.

The battery cell is a secondary battery, and may be configured into a pouch-type secondary battery. Such a battery cell may be composed of a plurality of cells, and the plurality of battery cells may be mutually stacked to be electrically connected to each other, thereby forming the battery cell stack 100. Each of the plurality of battery cells may include an electrode assembly, a cell case, and an electrode lead protruding from the electrode assembly.

The housing 200 houses the battery cell stack 100. The battery cell stack 100 housed inside the housing 200 can be physically protected through the housing 200.

A busbar frame 500 is located on the front and rear surfaces of the battery cell stack 100 to cover the front and rear surfaces of the battery cell stack 100, and can be connected with electrode leads extending from the plurality of battery cells. More specifically, electrode leads extending through the busbar frame 500 are coupled to the plurality of busbars 510 mounted on the outside surface of the busbar frame 500 to electrically connect the battery cells and the busbars 510.

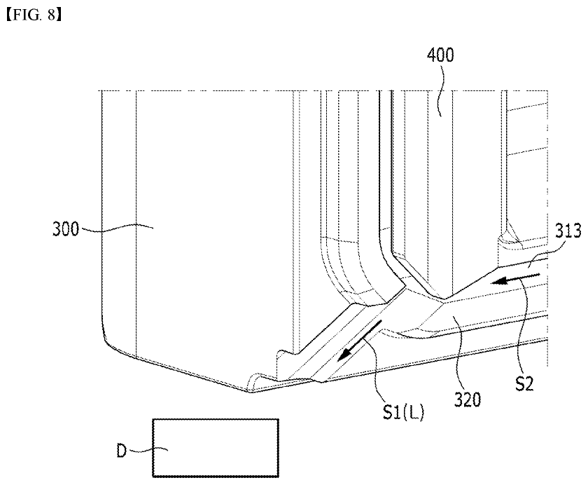

The end plates 300 are respectively formed on the outside of the busbar frame 500 to cover the battery cell stack 100 and the busbar frame 500. The busbar frame 500 may be connected to the inside lower end part 313 of the end plate 300 shown in FIG. 8.

The end plate 300 can protect the busbar frame 500, the battery cell stack 100, and various electrical equipment connected thereto from external impacts, and at the same time, guide the electrical connection between the battery cell stack 100 and an external power. An insulating cover 400 shown in FIG. 8 can be inserted between the end plate 300 and the busbar frame 500. The insulating cover 400 can cut off the electrical connection between the busbar frame 300 and the outside to insulate the battery module.

According to the present embodiment, a drainage channel L may be formed at both lower corner parts 310 where the end plate 300 meets the housing 200. The liquid inside the battery module may be discharged to the outside through the drainage channel L.

Conventionally, a liquid discharge structure is not separately provided in the battery module, and thus, when liquid accumulates inside the battery module, the busbars connected to the battery cells may be immersed in the liquid. When the immersed busbars are corroded, which may create a short circuit between busbars, resulting in a fire and deteriorating the performance of the battery module.

Therefore, according to the present embodiment, a drainage channel L is formed in both lower corner parts 310 of the end plate 300, and the liquid inside the battery module can be discharged to the outside through the drainage channel L, thereby preventing a short circuit between busbars. Further, it is also possible to prevent the electric components inside the module excluding the busbar from being infiltrated with liquid.

Below, a drainage structure according to one exemplary embodiment of the present disclosure will be described in more detail with reference to FIGS. 6 to 8.

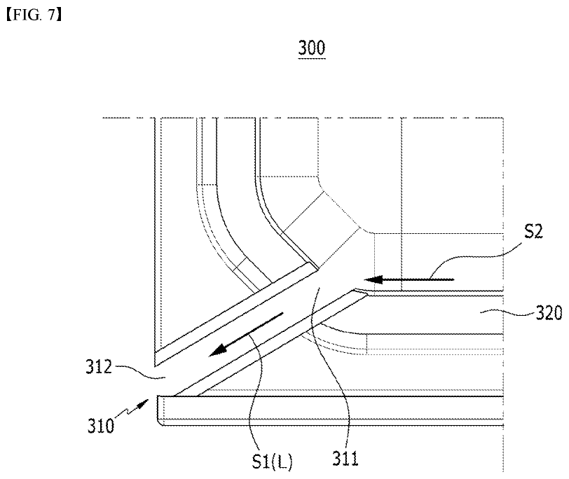

FIG. 7 is a plan view and FIG. 8 is a perspective view of the inside surface of the end plate according to one exemplary embodiment of the present disclosure.

As illustrated in FIGS. 6 to 8, in the battery module according to the present embodiment, a portion where the end plate 300 and the housing 200 meet may be joined by welding. As illustrated in FIG. 6, a welding line can be formed where the end plate 300 and the housing 200 meet except for the portion in which the drainage channel L is formed. Both the lower corner parts 310 of the end plate 300 and the corner parts of the housing 200 are the portions that have not been welded even in the related art, and due to the formation of the drainage channel L, the weld-coupling force between the end plate 300 and the housing 200 may not be reduced.

As illustrated in FIGS. 7 and 8, the drainage channel L has a first slope S1 from the inside corner part 311 of the lower end of the end plate 300 toward the outside corner part 312 of the lower end of the end plate 300. Further, the inside lower end part 313 of the end plate 300 connected to the drainage channel L may have a second slope S2 toward the drainage channel L. The first slope S1 may have a larger slope/angle of inclination than that of the second slope S2.

According to the present embodiment, the second slope S2 may have a gradient of 2 degrees. The liquid formed inside the battery module may be collected at the inside lower end part 313 of the end plate 300 due to gravity. The second slope S2 of the inside lower end part 313 has a gradient of 2 degrees in a direction in which the drainage channel L is located, so that the liquid collected in the inside lower end part 313 may flow along the inside lower end part into the drainage channel L. Since the first slope S1 of the drainage channel L has a larger inclination angle than the second slope S2 of the inside lower end part 313, the liquid that flows into the drainage channel L may be discharged to the outside of the battery module along the drainage channel L having the second slope S2.

A rim part 320 protruding toward the housing 200 is formed at the edge of the end plate 300, and the drainage channel L may be formed in the rim part 320. As illustrated in FIG. 8, an upper part of the drainage channel L and the inside lower end part 313 can be connected to the lower end part of the insulating cover 400. Thereby, condensed water, etc. formed on the surface of the insulating cover 400 flows down to the inside lower end part 313 formed on the lower side of insulating cover 400 along the surface of the insulating cover 400 due to gravity, and then can flow into the drainage channel L along the second slope S2 of the inside lower end part 313.

The busbar frame 500 shown in FIG. 5 can also be connected to an upper part of the drain channel L and the inside lower end part 313 shown in FIGS. 7 and 8. Thereby, the condensed water or the like formed on the surface of the busbar frame 500 can flow down to the inside lower end part 313 formed on the lower side of the busbar frame 500, along the surface of the plurality of busbars 510 mounted on the outside of the busbar frame 500 due to gravity, and then can flow into the drainage channel L along the second slope S2 of the inside lower end part 313.

As illustrated in FIG. 8, a drainage device D may be formed outside the drainage channel L of the battery module. The drainage device D may be connected to the drainage channel L to collect the liquid discharged to the drainage channel L, so that the liquid can be discharged to the outside of the battery pack mounted with at least one battery module.

The above-mentioned battery pack may have one or more of the battery modules according to the exemplary embodiment of the present disclosure packed together with a battery management system (BMS) and a cooling device that controls and manages the battery's temperature, voltage, etc.

The battery pack can be applied to various devices, which can be used with a vehicle means such as an electric bicycle, an electric vehicle, or a hybrid vehicle, but the present disclosure is not limited thereto, and is applicable to various devices capable of using a battery module, which also falls under the scope of the present disclosure.

Although the invention has been shown and described above with reference to the preferred embodiments, the scope of the present disclosure is not limited thereto, and numerous other modifications and embodiments can be devised by those skilled ins the art, without departing from the spirit and scope of the invention described in the appended claims. Further, these modified embodiments should not be understood individually from the technical spirit or perspective of the present disclosure. housing

1. A battery module comprising:
a battery cell stack comprising a plurality of battery cells;
a housing for the battery cell stack;
a pair of end plates covering the front and rear surfaces of the battery cell stack, respectively; and
a drainage channel at both lower corners of at least one of the pair of end plates where the at least one of the pair of end plates meets the housing.

2. The battery module according to claim 1, wherein:
each of the pair of the end plates is welded to the housing where the end plate meets the housing, excluding a portion where the drainage channel is formed.

3. The battery module according to claim 1, wherein:
the drainage channel has a first slope toward an outside corner of a lower end of the end plate connected to the drainage channel, and an inside lower end part of the end plate connected to the drainage channel has a second slope toward the drainage channel.

4. The battery module according to claim 3, wherein:
an inclination angle of the first slope is larger than an inclination angle of the second slope.

5. The battery module according to claim 1, wherein:
the drainage channel extends from an inside corner of a lower end of the corresponding end plate to an outside corner of the lower end of the end plate.

6. The battery module according to claim 1, wherein:
an edge of each of the pair of end plates comprises a rim part protruding toward the housing, and
the rim part comprises the drainage channel.

7. The battery module according to claim 1, further comprising:
an insulating cover between the battery cell stack and each of the pair of end plates, wherein
an inside lower end part of the corresponding end plate is formed on a lower side of the insulating cover.

8. The battery module according to claim 1, further comprising:
a pair of busbar frames positioned on the front and rear surfaces of the battery cell stack, wherein
each of the busbar frames is connected to an upper part of an inside lower end part of the corresponding end plate.

9. The battery module according to claim 8, wherein:
a plurality of busbars are mounted on the outside surface of each of the busbar frames, and
the plurality of busbars are connected to the upper part of the inside lower end part of the corresponding end plate.

10. A battery pack comprising:
the battery module according to claim 1; and
a drainage device connected to the drainage channel of the battery module.
